(19) United States
(12) Patent Application Publication
(10) Pub. No.: US 2002/0097683 A1
(43) Pub. Date: Jul. 25, 2002

(54) ATM switch

(76) Inventors: Koichi Yamamoto, Kawasaki (JP); Hiromasa Maebashi, Kawasaki (JP); Naokazu Kawamura, Kawasaki (JP); Minoru Yamaguchi, Kawasaki (JP); Naoki Oiri, Kawasaki (JP)

Correspondence Address: ROSENMAN & COLIN LLP, 575 MADISON AVENUE, NEW YORK, NY, 10022-2585, US

(21) Appl. No.: 09/785,579

(22) Filed: Feb. 16, 2001

(30) Foreign Application Priority Data
Nov. 21, 2000 (JP) 2000-354698

(51) Int. Cl. H04L 12/26

(52) U.S. Cl. 370/242; 370/244

(57) ABSTRACT

In an ATM switch, upon the occurrence of a line fault, an SNMP agent of an ATM switch on a called side detects a line fault and notifies the line fault to a calling side by a trap signal. An SNMP agent having an SNMP manager function of an ATM switch on the calling side receives the trap signal. A line manager specifies a line on which a fault has occurred based on line fault information of the trap signal and switches over to a predetermined alternate line. Also, the ATM switch has a PNNI interface mounted thereon and notifies a PNNI line fault to the calling side by the trap signal.

### Background of the Invention

1. Field of the Invention

The present invention relates to a switch, and in particular to a switch which can attend to a line fault.

For example, an ATM switch, which operates based on cells, can transfer all kinds of information at a high speed. In the ATM switch, accelerating a switchover to an alternate line or circuit upon a fault occurrence on a trunk line is important for e.g. the transmission of real-time information and the reduction of a data discarding or abolishing amount.

2. Description of the Related Art

A prior art routing control in an ATM switch network is prescribed by a PNNI (Private Network to Network Interface) protocol. Two interface protocols named routing and signaling are defined in the PNNI protocol.

The PNNI routing protocol distributes the information of the network topology and the route or path to an ATM switch which is participating in the network. It becomes possible for the ATM switch to detect the shortest route to a transmitting destination ATM switch and to automatically prepare a routing table based on the information.

The PNNI signaling protocol executes a connection setup between ATM switches.

Upon the occurrence of a fault on a PNNI trunk line between ATM switches, a routing controller of the ATM switch recognizes the fault based on the information of the network topology and the path distributed by the PNNI routing protocol, selects a normal line, and makes an SVC (Switched Virtual Connection) path and an SPVC (Soft Permanent Virtual Connection) path reroute with the PNNI signaling protocol to restore the communication.

In order to prevent the collision of messages for setting up the SPVC path, it is required that an ATM switch (owner station: calling or call-out side) for transmitting a setup message and an ATM switch (non-owner station: called or call-in side) for receiving the setup message are predetermined.

Also, the transmission/reception of data between ATM switches is generally performed with a two-core optical cable having different lines respectively for transmitting/receiving. For this reason, a line fault generally occurs on either one of the transmitting/receiving lines in many cases.

In the PNNI protocol, a protocol stack for the ATM switch to detect the fault of the trunk line is prescribed as follows:

(1) Detection of a layer 2 fault is performed by Q.2110 and Q.2130. It takes 7-22 seconds to detect the fault.

(2) After the detection (1), T.309 which is a layer 3 fault timer is issued. The time set to this timer is 10 seconds.

Through the operations of (1) and (2), it takes 17-32 seconds to detect the fault of the trunk line.

Namely, since a rerouting operation of the SPVC path in the ATM switch of the owner station (calling side) is started by a time-out (17-32 seconds) of a layer 2 regular diagnosis, a high-speed switchover upon the occurrence of the trunk line fault can not be performed.

On the other hand, the ATM switch of the non-owner station (called side) is provided with the protocol stack for recognizing a disconnection of a receiving line (layer 1 fault), for immediately re-setting up an alternate line, and for sending a warning signal to the ATM switch of the owner station.

By receiving the warning signal or the like, the ATM switch of the owner station can recognize the detection of the line fault on the transmitting side of its own station. However, in the presence of a transmission device between the ATM switches of the non-owner station and the owner station, the warning signal is absorbed in the transmission device, thereby failing to reach the ATM switch of the owner station which should send the setup message.

Thus, in the prior art ATM switch, there has been a problem that a high-speed switchover to an alternate line can not be performed in the PNNI protocol upon the occurrence of the trunk line fault on the transmitting side. Also, there has been a problem that a warning signal is absorbed in a transmission device, thereby failing to reach the ATM switch of the owner station in the protocol stack of the layer 1 receiving line fault.

### SUMMARY OF THE INVENTION

### It is accordingly an object of the present invention to provide a switch such as an ATM switch which performs a high-speed setup of an alternate line upon the occurrence of a line fault.

A general network management in the ATM switch is prescribed by a network management protocol such as an SNMP protocol. This SNMP protocol monitors the security and the fault of the network, reduces the work of network management persons, and keeps the network safely operated.

The network manager is called a manager station, which is set in a place not shown in the example of FIG. 1, for example. The manager station manages ATM switches 11-13 having SNMP agents.

Each of the ATM switches 11-13 obtains information necessary for the management for its own station, and notifies the information to the manager station by utilizing the SNMP protocol. The notification to the manager station is performed based on a demand by the manager station or independently performed by each of the ATM switches 11-13 with an event-driven trap signal.

The inventors of the present invention have remarked that if the transmission/reception of the trap signal not only between the manager station and the SNMP agent but also between the SNMP agents is performed, a high-speed line fault notification can be realized.

Namely, in order to achieve the above-mentioned object, a switch according to claim 1 comprises: an agent for detecting a line fault and for notifying line fault information to a calling side by a trap signal.

The principle of the ATM switch according to the present invention will now be described referring to FIG. 1.

The ATM switch 11 on the calling side (owner station) and the ATM switch 12 on the called side (non-owner station) are mutually connected with a trunk line 21. Furthermore, the ATM switches 11 and 12 are connected to the ATM switch 13 respectively with trunk lines 22 and 23.

Each of the ATM switches 11-13 is provided with an SNMP agent 60 while SNMP agent 60 in ATM switch 13 is not shown.

The trunk line 21 transmits data from the ATM switch 11 to the ATM switch 12. For example, the trunk line 21 includes a PNNI trunk line 21_1 including an SVC path and an SPVC path, a PNNI trunk line 21_2 including the SVC path and the SPVC path which transmit data in the opposite direction thereof, a trunk line 21_3 which transmits data from the SNMP agent 60 in the ATM switch 11 to the SNMP agent 60 in the ATM switch 12, and a trunk line 21_4 which transmits data in the opposite direction thereof.

It is to be noted that a transmission device between the ATM switches 11 and 12 is not shown in FIG. 1.

The SNMP agent 60 in the ATM switch 12 on the called side regards the SNMP agent 60 of the ATM switch 11 on the calling side as the manager station to immediately notify a detected line fault to the SNMP agent 60 in the ATM switch 11 by the trap signal of an SNMP event driven type.

Thus, since a line abnormal signal of the ATM switch 12 on the called side is a trap signal, the line fault can be notified to the ATM switch 11 on the calling side at a higher speed compared with e.g. the case of a line fault detection based on a level 2 regular diagnosis by the prior art PNNI protocol. Also, since the trap signal is not a level 1 signal, it is not absorbed in the transmission device on the way.

Also, a switch of the present invention according to claim 2 comprises: an agent for receiving line fault information by a trap signal, and a line manager for specifying a line on which a fault has occurred based on the line fault information from the agent and for switching over to a predetermined alternate line.

Namely, in FIG.1, the SNMP agent (manager) 60 in the ATM switch 11 on the calling side has a function of an SNMP manager which receives a trap signal. The SNMP agent 60 receives line fault information from the SNMP agent 60 in the ATM switch 12 on the called side by the trap signal, and notifies the information to a line manager (not shown).

The line manager specifies a line on which a fault has occurred based on the line fault information to switch over the line to a predetermined alternate line.

Thus, it becomes possible to switch over the faulted line to the alternate line at a high speed.

Also, in the present invention of claim 3 according to the present invention of claim 1, the line fault may comprise a line fault detected by a network-to-network protocol such as a PNNI protocol.

Namely, the ATM switch has a PNNI interface mounted thereon, and the line fault may be a line fault detected by the PNNI protocol.

Thus, it becomes possible to notify the PNNI line fault to the calling side.

Also, in the present invention of claim 4 according to the present invention of claim 2, the line manger may manage a line based on an interface with a network-to-network protocol, the line fault information may comprise information of a line fault detected by the network-to-network protocol, and a line may be switched over to a network-to-network alternate line based on the trap signal.

Namely, the line manager has the PNNI interface mounted thereon, and the line manager switches over a line to a PNNI alternate line based on the trap signal.

Thus, it becomes possible to switch over the faulted PNNI trunk line to the PNNI alternate line.

Also, the present invention of claim 5 according to the present invention of claim 2 may further comprise an SPVC path manager for setting up an alternate line of a path such as an SPVC path based on the line fault information.

Namely, the SPVC path manager can set up the alternate line of the SPVC path based on the line fault information. Thus, it becomes possible to re-set up the alternate line of the SPVC path at a high speed.

### BRIEF DESCRIPTION OF THE DRAWINGS

FIG. 1 is a block diagram showing a principle of an ATM switch according to the present invention;

FIG. 2 is a block diagram showing an embodiment of an ATM switch according to the present invention;

FIG. 3 is a block diagram showing an example of a trunk line fault state in a network composed of an ATM switch according to the present invention;

FIG. 4 is a block diagram showing an operation example on a non-owner side of an ATM switch according to the present invention;

FIG. 5 is a block diagram showing an operation example on an owner side of an ATM switch according to the present invention;

FIG. 6 is a flow chart (1) showing an operation example on a non-owner side of an ATM switch according to the present invention;

FIG. 7 is a flow chart (2) showing an operation example on a non-owner side of an ATM switch according to the present invention;

FIG. 8 is a flow chart (1) showing an operation example on an owner side of an ATM switch according to the present invention;

FIG. 9 is a flow chart (2) showing an operation example on an owner side of an ATM switch according to the present invention; and

FIG. 10 is a flow chart showing a relaying operation example in an ATM switch according to the present invention.

Throughout the figures, like reference numerals indicate like or corresponding components.

### DESCRIPTION OF THE EMBODIMENTS

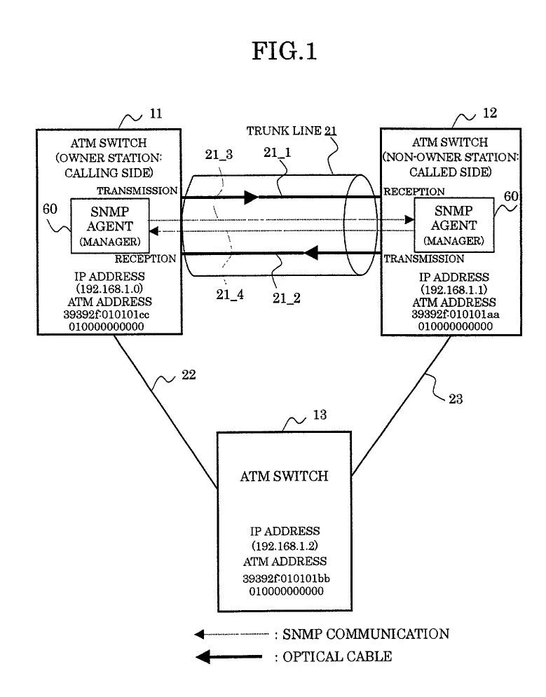

Hereinafter, an embodiment of an ATM switch according to the present invention will be described referring to the network arrangement shown in FIG. 1. In this network, routing and connection setup are performed based on a PNNI protocol. Also, as mentioned above, the transmission device between the ATM switches is not shown in FIG. 1.

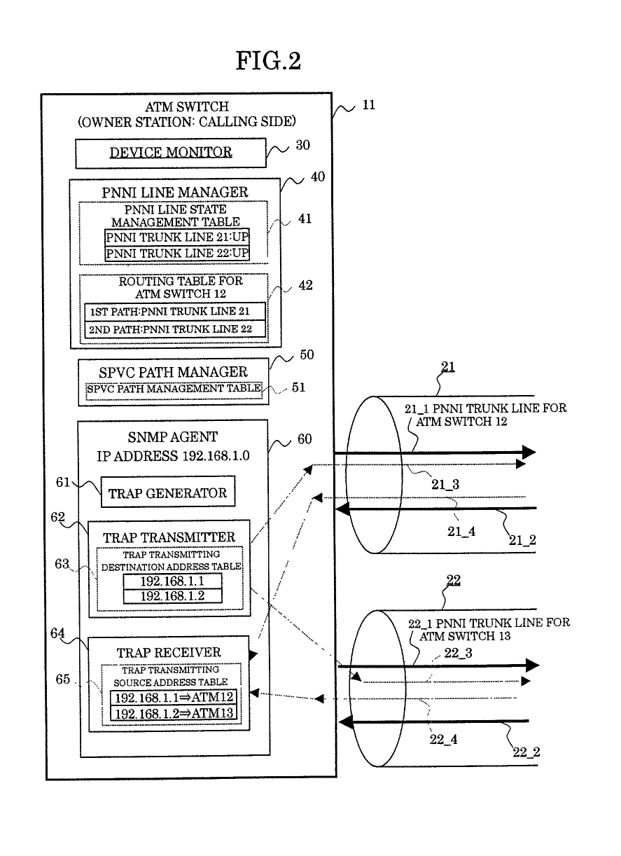

FIG. 2 shows an embodiment of the ATM switch 11 according to the present invention. In this embodiment, the ATM switch 11 is composed of a device monitor 30, a PNNI line manager 40, an SPVC path manager 50, and an SNMP agent 60.

The PNNI line manager 40 is provided with a PNNI line state management table 41 and a routing table 42 for the ATM switch 12, the SPVC path manager 50 is provided with an SPVC path management table 51, and the SNMP agent 60 is provided with a trap generator 61, a trap transmitter 62 having a trap transmitting destination address table 63, and a trap receiver 64 having a trap transmitting source address table 65.

The device monitor 30 sequentially monitors the state of a monitored portion (e.g. each line port or the like) in its own ATM switch 11 by using an in-device exclusive (extension) line in a short time.

When detecting the state change of the monitored portion (e.g. layer 1 line's state transition: normal state→faulted state, or faulted state→normal state), the device monitor 30 immediately notifies the change to the PNNI line manager 40 and the SNMP agent 60 by utilizing the in-device exclusive line (bus).

The PNNI line manager 40 dynamically or statistically manages the PNNI line state management table 41 and the routing table 42 recognized by a PTSP (PNNI Topology State Packet) or the like including a Hello packet and a PTSE (PNNI Topology State Element) of a general PNNI protocol.

The PNNI line manager 40 manages the state (UP or DOWN) of PNNI trunk lines on the management table 41 to perform routing the first path which is the optimum routing path based on the routing table 42.

The PNNI line state management table 41 and the routing table 42 will be later described referring to Tables 1(1) and 1(2), and Tables 2(1), and 2(2).

The SPVC path manager 50 monitors and manages whether or not the SPVC paths can normally communicate based on the line state of the PNNI line manager 40.

Namely, the SPVC path manager 50 manages the ATM addresses of the SPVC paths on the owner (calling) side and on the non-owner (called) side, and whether the state of the SPVC path is a connected state (UP) or a standby state (DOWN) based on the SPVC path management table 51. The SPVC path management table 51 will be later described referring to Tables 1(3) and 2(3).

Also, the SPVC path manager 50 includes an owner (calling) station which transmits a setup message for setting up the SPVC path and a non-owner (called) station which receives the setup message.

The SNMP agent 60 controls and manages the entire SNMP communication, the trap generator 61 generates a trap signal based on a general SNMP protocol based on detection information sent from the device monitor 30, and the trap transmitter 62 transmits the trap signal based on the trap transmitting destination address table 63 statistically or dynamically managed.

Also, the SNMP agent 60 is provided with the trap receiver 64 having a trap receiving function within an SNMP manager function. The trap receiver 64 receives the trap signal transmitted from another ATM switch and recognizes the transmitting source ATM switch based on the trap transmitting source address table 65.

The address table 65 will be later described referring to Tables 1(4) and 2(4).

The ATM switch 11 is connected to the trunk lines 21_1-21_4 included in the trunk line 21 for the ATM switch 12 as shown in FIG. 1. Similarly, the ATM switch 11 is connected to the trunk lines 22_1-22_4 included in the trunk line 22 for the ATM switch 13 (see FIG. 1).

The trunk lines 21_3 and 22_3 among these are connected to the trap transmitter 62, and the trunk lines 21_4 and 22_4 are connected to the trap receiver 64.

The arrangements of the ATM switches 12 and 13 are the same as those of the ATM switch 11.

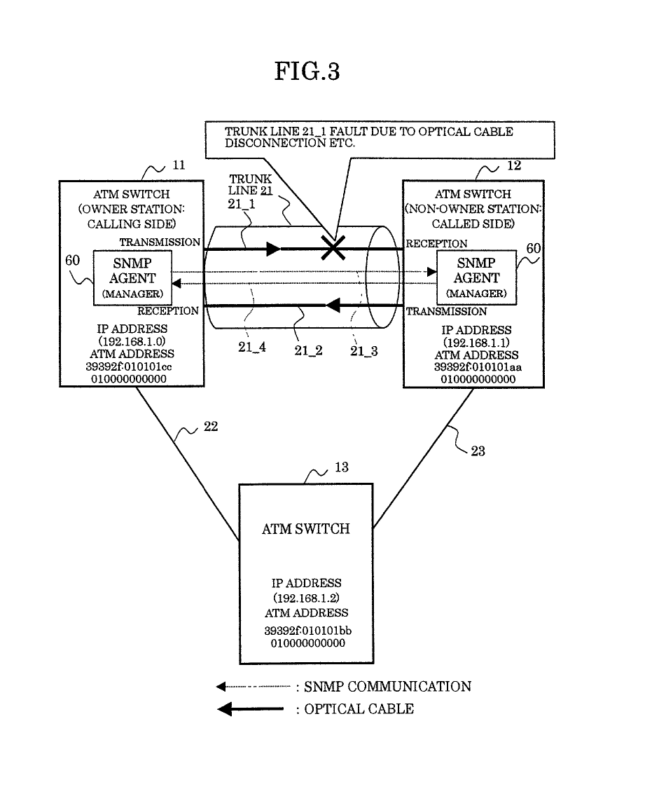

FIG. 3 shows a case where a fault such as a disconnection (shown by a mark×in FIG. 3) has occurred on the trunk line (optical cable) 21_1.

It is to be noted that the IP addresses and the ATM addresses of the ATM switches 11-13 are respectively assumed to be as follows:

(192.168.1.0;39392f:010101cc010000000000)

(192.168.1.1;39392f:010101aa010000000000)

(192.168.1.2;39392f:010101bb010000000000)

The following Tables 1 and 2 respectively show table examples included in the ATM switches 12 and 11.

TABLE 1
(1) PNNI LINE STATE MANAGEMENT TABLE 41

| TRUNK LINE | ATM ADDRESS OF ADJOINING | CONNECTION | PNNI LINE |
|---|---|---|---|
| NAME | SWITCH | PORT NO. | STATE |
| PNNI TRUNK | 39392f:010101cc010000000000 | 1-1-1 | UP→DOWN |
| LINE 21 | | | |
| PNNI TRUNK | 39392f:010101bb010000000000 | 2-1-1 | UP |
| LINE 23 | | | |

(2) ROUTING TABLE 42 FOR ATM SWITCH 11

| | TRUNK LINE | ATM ADDRESS OF ADJOINING | CONNECTION | PNNI LINE |
|---|---|---|---|---|
| PATH | NAME | SWITCH | PORT NO. | STATE |
| 1st PATH | PNNI TRUNK LINE | 39392f:010101cc010000000000 | 1-1-1 | UP |
| | 21 | | | |
| 2nd PATH | PNNI TRUNK LINE | 39392f:010101bb010000000000 | 2-1-1 | UP |
| | 23 | | | |

(3) SPVC PATH MANAGEMENT TABLE 51

| CALL | | | | WORKING |
|---|---|---|---|---|
| CLASSIFI- | ATM ADDRESS ON | ATM ADDRESS ON | SPVC | TRUNK |
| CATION | OWNER SIDE | NON-OWNER SIDE | STATE | LINE |
| NON- | 39392f:010101cc010000000000: | 39392f:010101aa010000000000: | UP→DOWN | TRUNK |
| OWNER | 000000000001:00 | 000000000001:00 | | LINE 21 |
| NON- | 39392f:010101bb010000000000: | 39392f:010101aa010000000000: | DOWN | TRUNK |
| OWNER | 000000000003:00 | 000000000003:00 | | LINE 23 |
| NON- | 39392f:010101cc010000000000: | 39392f:010101aa010000000000: | UP→DOWN | TRUNK |
| OWNER | 000000000002:00 | 000000000002:00 | | LINE 21 |

(4) TRAP TRANSMITTING SOURCE ADDRESS TABLE 65

| SWITCH NAME | ATM ADDRESS | IP ADDRESS |
|---|---|---|
| ATM SWITCH 11 | 39392f:010101cc010000000000 | 192.168.1.0 |
| ATM SWITCH 13 | 39392f:010101bb010000000000 | 192.168.1.2 |

TABLE 2
(1) PNNI LINE STATE MANAGEMENT TABLE 41

| TRUNK LINE | ATM ADDRESS OF ADJOINING | CONNECTION | PNNI LINE |
|---|---|---|---|
| NAME | SWITCH | PORT NO. | STATE |
| PNNI TRUNK | 39392f:010101aa010000000000 | 1-1-1 | UP→D0WN |
| LINE 21 | | | |
| PNNI TRUNK | 39392f:010101bb010000000000 | 2-1-1 | UP |
| LINE 22 | | | |

(2) ROUTING TABLE 42 FOR ATM SWITCH 12

| | | ATM ADDRESS OF ADJOINING | CONNECTION | |
|---|---|---|---|---|
| PATH | TRUNK LINE NAME | SWITCH | PORT NO. | PNNI LINE STATE |
| 1st PATH | PNNI TRUNK LINE | 39392f:010101aa010000000000 | 1-1-1 | UP→DOWN |
| | 21 | | | |
| 2nd PATH | PNNI TRUNK LINE | 39392f:010101bb010000000000 | 2-1-1 | UP |
| | 22 | | | |

(3) SPVC PATH MANAGEMENT TABLE 51

| CALL | | | | WORKING |
|---|---|---|---|---|
| CLASSIFI- | ATM ADDRESS | ATM ADDRESS | SPVC | TRUNK |
| CATION | ON OWNER SIDE | ON NON-OWNER SIDE | STATE | LINE |
| OWNER | 39392f:010101cc010000000000: | 39392f:010101aa010000000000: | UP→DOWN | TRUNK |
| | 000000000001:00 | 000000000001:00 | | LINE 21 |
| NON- | 39392f:010101bb010000000000: | 39392f:010101cc010000000000: | DOWN | TRUNK |
| OWNER | 000000000003:00 | 000000000003:00 | | LINE 22 |
| OWNER | 39392f:010101cc010000000000: | 39392f:010101aa010000000000: | UP→DOWN | TRUNK |
| | 000000000002:00 | 000000000002:00 | | LINE 21 |

(4) TRAP TRANSMITTING SOURCE ADDRESS TABLE 65

| SWITCH NAME | ATM ADDRESS | IP ADDRESS |
|---|---|---|
| ATM SWITCH 12 | 39392f:010101aa010000000000 | 192.168.1.1 |
| ATM SWITCH 13 | 39392f:010101bb010000000000 | 192.168.1.2 |

Tables 1(1) and 2(1) respectively show a PNNI line state management table 41 included in the PNNI line manager 40, while Tables 1(2) and 2(2) respectively show a routing table 42 for the other ATM switch.

The management table 41 is composed of a PNNI trunk line name, an ATM address of an adjoining switch connected to the trunk line, a connection port No., and a PNNI trunk line state.

It is to be noted that only the name of the PNNI trunk line for transmission is mentioned in the management table 41 of Table 1, only the name of the PNNI trunk line for reception is mentioned in the management table 41 of Table 2, and others are omitted. Also, the reference numerals of the PNNI trunk lines 21_1, 22_1, and 23_1 are abbreviated as the reference numerals 21, 22, and 23.

The PNNI line state is set to “UP” in a connectable state, and is set to “DOWN” in a non-connectable state.

The routing table 42 is the management table 41 to which an item of transmitting path is further added. The optimum 1st and 2nd paths among the PNNI trunk lines for transmitting are set in the routing table 42.

It is to be noted that the routing table 42 is prepared corresponding to each destination ATM switch. In Tables 1(2) and 2(2), only the routing tables 42 respectively corresponding to the destination ATM switches 11 and 12 are shown.

Also, in the same way as the management table 41, the reference numerals of the PNNI trunk lines are abbreviated as the reference numerals 21, 22, and 23.

Tables 1(3) and 2(3) show an SPVC path management table 51 included in the SNMP agent 60. The management table 51 is composed of a call classification, an ATM address on the owner side, an ATM address on the non-owner side, an SPVC state, and a working trunk line.

Tables 1(4) and 2(4) show a trap transmitting source address table 65 included in the trap receiver 64. The address table 65 is composed of a switch name, an ATM address, and an IP address.

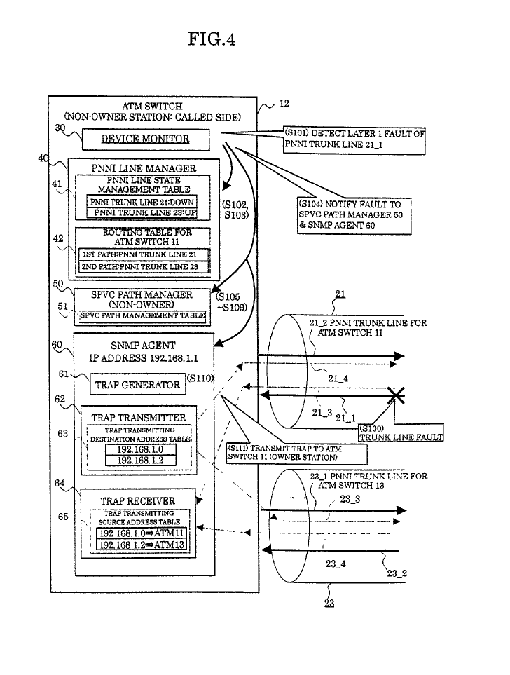

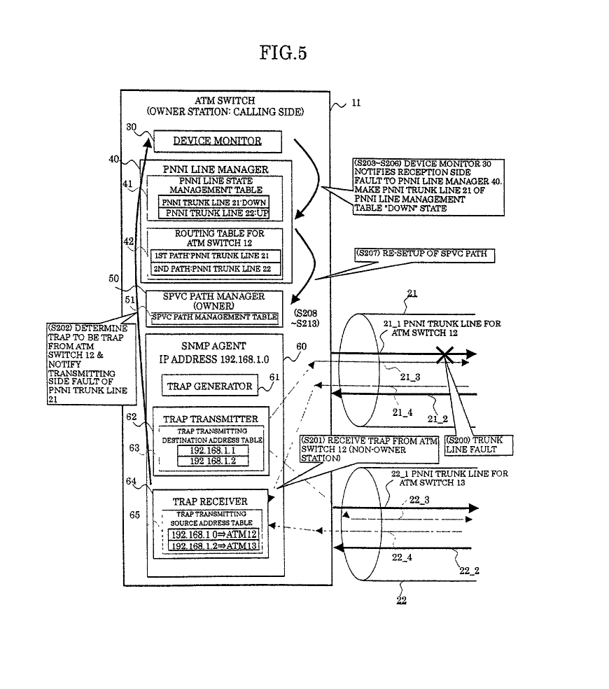

FIGS. 4 and 5 respectively show operation examples of the ATM switch 12 on the called side and the ATM switch 11 on the calling side when a fault has occurred in the PNNI trunk line (optical cable) 21_1 shown in FIG. 3.

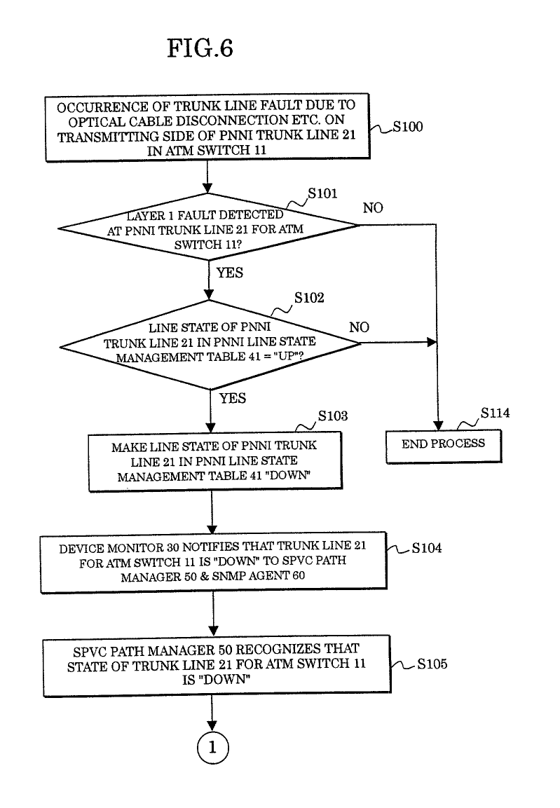

FIGS. 6, 7, 8, 9, and 10 respectively show operation flows of the ATM switches 12, 11, and 13.

Hereinafter, the operation examples of the ATM switch 12 in FIG. 4, the ATM switch 11 in FIG. 5, and the ATM switch 13 in case a fault has occurred in the PNNI trunk line 21_1 will be described based on FIGS. 6, 7, 8, 9, and 10.

It is to be noted that the ATM switches 11-13 in a normal state execute routing and signaling based on the PNNI protocol, and transmit monitoring information to the SNMP manager station within the network based on the SNMP protocol.

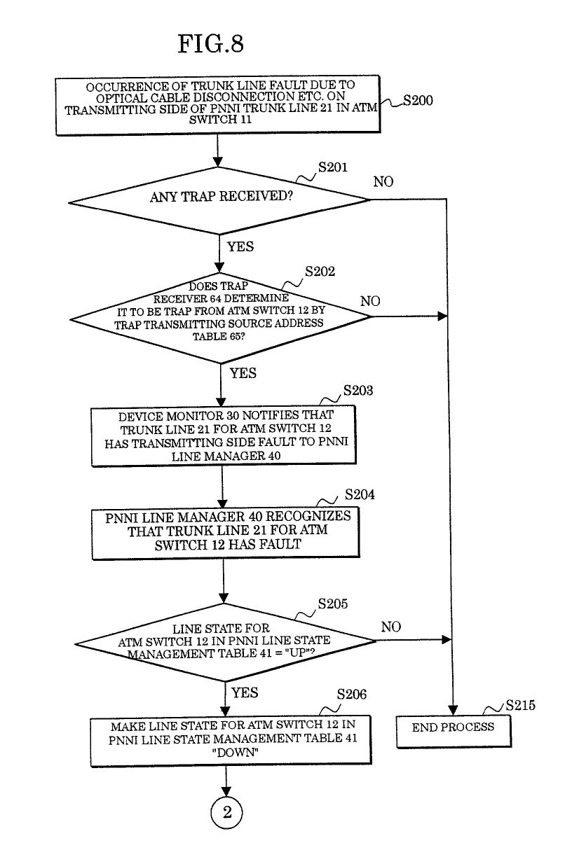

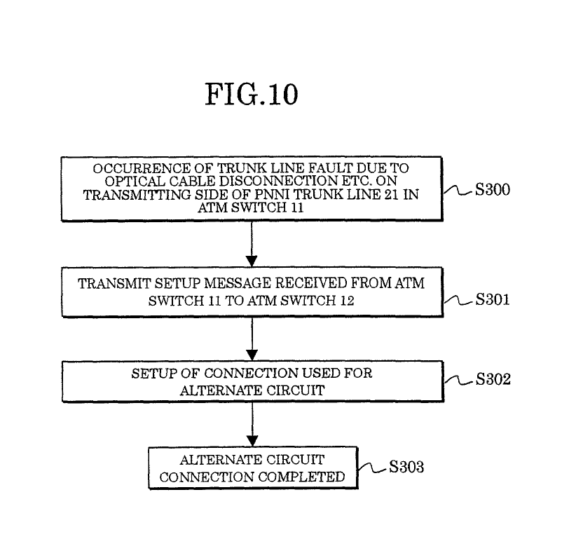

### Step S100 (FIG. 6), Step S200 (FIG. 8), and Step S300 (FIG. 10)

A fault occurs only in the PNNI trunk line 21_1 (hereinafter occasionally abbreviated as reference numeral 21) between the ATM switches 11 and 12 (FIGS. 4 and 5).

### Operation of ATM Switch 12

### Step S101 (FIG. 6)

The device monitor 30 detects the line fault as a layer 1 fault of the PNNI trunk line 21_1 for the ATM switch 11. Namely, the device monitor 30 continuously monitors a photo detection level of the trunk lines, and determines the interruption of a photo detection (occurrence of layer 1 fault) when the minimum photo detection power is equal to or less than e.g. −28 dbm prescribed by the ATM forum.

When the interruption of the photo detection is not detected, the process proceeds to step S114 at the end.

### Steps S102-S104 (FIG. 6)

The device monitor 30 updates the “UP” state of the PNNI trunk line 21 of the management table 41 in the PNNI line manager 40 to the “DOWN” state (see Table 1(1)). Furthermore, the device monitor 30 transmits information indicating that the PNNI trunk line 21 for the ATM switch 11 is in the “DOWN” state to the SPVC path manager 50 and the SNMP agent 60.

It is to be noted that if the state of the PNNI trunk line 21 in the management table 41 is already in the “DOWN” state, the process proceeds to step S114 at the end.

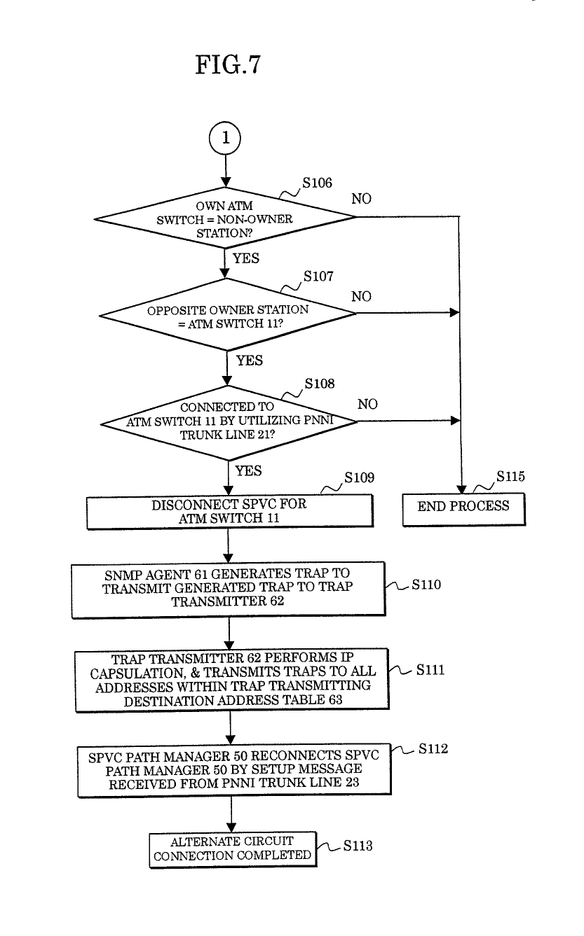

### Step S105 (FIG. 6), Steps S106-S109 (FIG. 7)

The SPVC path manager 50 retrieves the SPVC path using the PNNI trunk line 21 between its own ATM switch 12 of the non-owner station and the opposite ATM switch 11 of the owner station, from the SPVC path management table 51 (see Table 1(3)) based on the received information, so that the path is released or disconnected.

When the own ATM switch 12 is the owner station, or when it is the non-owner station but the opposite owner station is not the ATM switch 11, the process proceeds to step S115 at the end.

### Steps S110 and S111 (FIG. 7)

In the SNMP agent 60, the trap generator 61 receives the fault information of the PNNI trunk line 21_1, and generates the trap signal of the fault (layer 1 fault) in the PNNI trunk line 21 addressed to the ATM switch 11, so that the trap transmitter 62 performs the IP capsulation of the trap signal to be transmitted.

At this time, the IP address of the destination ATM switch 11 is retrieved from the trap transmitting source address table 65 (see Table 1(4)). It is to be noted that the IP address is assigned to the SNMP agent 60.

Also, the trap transmitter 62 may send the trap signals to all of the ATM switches 11 and 13 within the trap transmitting destination address table 63, and determine whether or not the trap signal is related to the own station on the ATM switch side which has received the trap.

### Operation of ATM switch 11

### Steps S201 and S202 (FIG. 8)

The trap receiver 64 receives the IP capsulated trap signal, and determines it to be the trap signal from the ATM switch 12 by referring to the trap transmitting source address table 65 (see Table 2(4)) based on the transmitting source IP address.

The trap receiver 64 recognizes that the ATM switch 12 has detected the layer 1 fault of the ATM switch 11 based on the information within the trap signal, and notifies the information to the device monitor 30.

When the trap receiver 64 has not received the trap signal, the process proceeds to step S215 at the end.

### Step S203 (FIG. 8)

The device monitor 30 which has received the information determines that the fault has occurred in the PNNI trunk line 21_1 on the transmitting side to be notified to the PNNI line manager 40.

### Steps S204-S206 (FIG. 8)

The PNNI line manager 40 updates the “UP” state of the PNNI trunk line 21 in the PNNI line state management table 41 to the “DOWN” state (see Table 2(1)). In case the state of the PNNI trunk line 21_1 was originally in the “DOWN” state, the process proceeds to step S215 at the end.

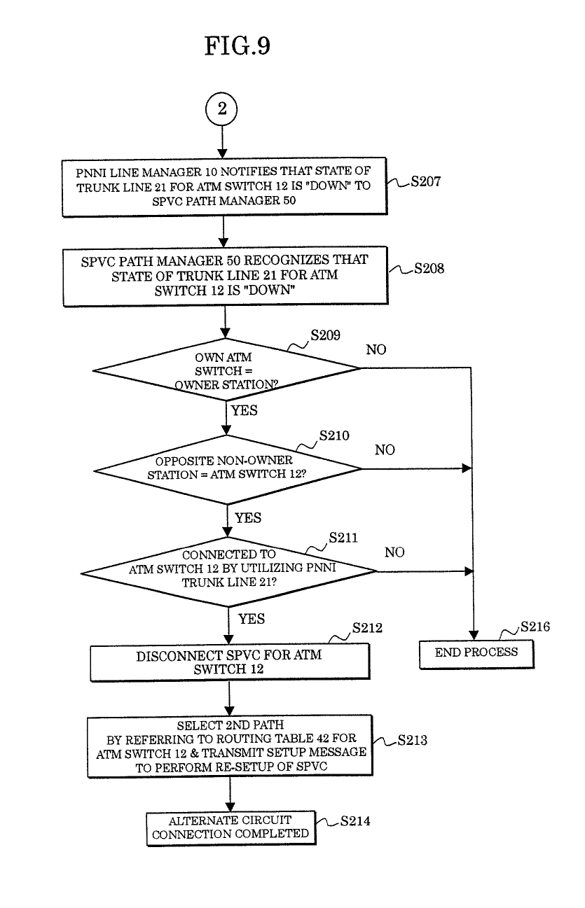

### Step S207 (FIG. 9)

The PNNI line manager 40 notifies the “DOWN” information to the SPVC path manager 50.

### Steps S208-S212 (FIG. 9)

Based on the information, the SPVC path manager 50 retrieves an SPVC path between the own switch of the owner station and the opposite ATM switch 12 of the non-owner station, and connected to the ATM switch 12 utilizing the PNNI trunk line 21 by referring to the SPVC path management table 51 (see Table 2(3)), so that the SPVC path is disconnected by making the SPVC state “DOWN” from the “UP” state.

When the ATM switch 11 is the non-owner station, the opposite ATM switch 12 is the owner station, or the ATM switch 11 is connected to the ATM switch 12 without utilizing the PNNI trunk line 21, the process proceeds to step S216 at the end.

### Step S213 (FIG. 9)

Then, the SPVC path manager 50 selects the second path of the PNNI trunk line 22 by referring to the routing table 42 (see Table 2(2)) for the ATM switch 12, and transmits the setup message for re-setting up the SPVC path in the trunk line 22.

### Operation of the ATM Switch 13 (Relay Station)

### Steps S301 and S302 (FIG. 10)

The ATM switch 13 relays and transfers the setup message received from the ATM switch 11 to the ATM switch 12 through the PNNI trunk line 23, and sets up the connection used for an alternate circuit.

### Operation of ATM Switch 12

### Step S112 (FIG. 7)

The ATM switch 12 reconnects the SPVC path based on the setup message received from the PNNI trunk line 23.

### Steps S113. S214 (FIG. 9), and S303 (FIG. 10)

In the ATM switches 11, 12, and 13, the connection of the alternate line is completed.

Thus, it becomes possible to re-set up the alternate line of the SPVC path at a high speed.

Similarly, when receiving the abnormality of the PNNI trunk line (SVC path) on the transmitting side by the trap signal in the ATM switch 11 on the calling side, the PNNI line manager 40 re-sets up the alternate line of the second path.

Thus, it becomes possible to re-set up the alternate line of the SVC path at a high speed.

As described above, an ATM switch according to the present invention is arranged such that an SNMP agent of an ATM switch on a called side detects a line fault and notifies the line fault to a calling side by a trap signal, an SNMP agent having an SNMP manager function of an ATM switch on the calling side receives the trap signal, and a line manager specifies a line on which a fault has occurred based on line fault information of the trap signal and switches over to a predetermined alternate line. Therefore, it becomes possible to switch over a faulted line to its alternate line at a high speed.

Also, the ATM switch according to the present invention is arranged such that the ATM switch has a PNNI interface mounted thereon and a PNNI line fault is notified to the calling side by the trap signal. Therefore, it becomes possible to switch over the PNNI faulted line (SVC path) to the alternate line at a high speed.

Also, the ATM switch according to the present invention is arranged such that an SPVC path manager sets up an alternate line of an SPVC path based on the line fault information on the calling side of the ATM switch. Therefore, it becomes possible to re-set up the alternate line of the SPVC path at a high speed.

What we claim is:

1. A switch having a network management protocol mounted thereon comprising:
an agent for detecting a line fault and for notifying line fault information to a calling side by a trap signal.

2. A switch having a network management protocol mounted thereon comprising:
an agent for receiving line fault information by a trap signal, and
a line manager for specifying a line on which a fault has occurred based on the line fault information from the agent and for switching over to a predetermined alternate line.

3. The switch as claimed in claim 1 wherein the line fault comprises a line fault detected by a network-to-network protocol.

4. The switch as claimed in claim 2 wherein the line manger manages a line based on an interface with a network-to-network protocol, the line fault information comprises information of a line fault detected by the network-to-network protocol, and a line is switched over to a network-to-network alternate line based on the trap signal.

5. The switch as claimed in claim 2, further comprising a path manager for setting up an alternate line of a path based on the line fault information.
